(19) United States
(12) Patent Application Publication
(10) Pub. No.: US 2017/0302430 A1
(43) Pub. Date: Oct. 19, 2017

(54) Asynchronous Interface For Communications Between Computing Resources That Are In Different Clock Domains

(71) Applicant: KnuEdge Incorporated, San Diego, CA (US)

(72) Inventor: Ramon Zuniga, San Diego, CA (US)

(21) Appl. No.: 15/098,257

(22) Filed: Apr. 13, 2016

(51) Int. Cl. H04L 7/00

(52) U.S. Cl. CPC H04L 7/0016

(57) ABSTRACT

A method is performed by a data transmitting computing resource operating in a first clock domain of a computing system to transfer data to a data receiving computing resource operating in a second clock domain of the computing system different from the first clock domain. The method includes placing data on a parallel data channel including a plurality of data lines connecting the data transmitting computing resource and the data receiving computing resource; waiting a predetermined amount of time after the placing of the data on the parallel data channel, the predetermined amount of time based on different propagation times of the plurality of data lines; and, after waiting the predetermined amount of time, notifying the data receiving computing resource that the data placed on the parallel data channel are valid.

### FIELD OF THE DISCLOSURE

The technologies described herein relate to computing resources of a computing system that communicate with each other, such that communications between those computing resources that are part of a same clock domain of the computing system are carried out using a synchronous interface, and communications between those computing resources that are part of different clock domains of the computing system are carried out using an asynchronous interface.

### BACKGROUND

A chip device can have a side (or diagonal) dimension of about 20-30 mm, while distances between logic gates, from which computing resources of the network on a chip device are constructed, are on the of order 20-30 nm. As a typical clock rate for communications on such a chip device is 1 GHz, which is equivalent to a period of 1 ns, and because there could be communication delays of 200 ps per mm of communication medium, distances for synchronous communication between computing resources of the chip device typically are kept very small compared to the chip size, e.g., to less than 200 μm. For these reasons, conventional chip devices use various synchronizing solutions, e.g., clock trees, to synchronize different clock domains for carrying out synchronous communications over the width/diagonal of the chip device. Synchronizing the different clock domains of a chip device in such a manner can consume about 20% of the device's power budget.

### SUMMARY

An asynchronous interface is disclosed herein for implementing a communications mechanism where data transfers between computing resources from different clock domains are independent of a relative clock frequency and/or phase delay for the different clock domains. For example, data packets can be reliably transferred, in accordance with the disclosed asynchronous communications interface, from a first cluster, that is part of a first clock domain of a chip device, to a second cluster that is part of a second clock domain of the chip device, even though the clocks of the two clusters are not synchronized. In this manner, the disclosed asynchronous communications interface can be implemented in a chip device to allow for globally asynchronous, locally synchronous (GALS) communications between computing resources of the two clusters of the chip device-that is, communications between computing resources that are part of a same cluster are carried out in a synchronous manner, and communications between computing resources of different clusters are carried out in an asynchronous manner, in accordance with the disclosed technologies.

In addition, the disclosed asynchronous communications interface also provides for flow control between two computing resources from different clock domains of the chip device and includes provisions for arbitration.

Particular aspects of the disclosed technologies can be implemented so as to realize one or more of the following potential advantages. For example, by having computing resources from different clock domains operate asynchronously to each other, a power distribution system of the disclosed chip device is simplified relative to a power distribution of a conventional chip device in which computing resources operate synchronously to each other by using various synchronizing solutions, e.g., clock trees. Further, timing closure can be simplified because there is no need to align the clocks on all computing resources of the disclosed chip device. In this manner, as the clocks of the computing resources of the disclosed chip device need not be aligned, in accordance with the disclosed technologies, dynamic current peaks at each clock edge can be spread to reduce peak current surge.

Additionally, in conventional communications interfaces, transmitter and recipient computing resources exchange pairs of request/acknowledge messages for each of respective data transfers there between. Such request/acknowledge round trips can be time consuming and slow down communications between different clock domains of a chip device. Communication efficiency can be improved by using the systems and techniques described herein, because the disclosed asynchronous interface also provides for flow control between two computing resources from different clock domains and includes provisions for arbitration. For instance, a grant is requested and granted only at the beginning of a transmission of a data packet, regardless of how many data transfers are necessary to complete the transmission of the data packet, without having to perform grant requests for each of the necessary data transfers.

Details of one or more implementations of the disclosed technologies are set forth in the accompanying drawings and the description below. Other features, aspects, descriptions and potential advantages will become apparent from the description, the drawings and the claims.

### BRIEF DESCRIPTION OF THE DRAWINGS

FIG. 1A is a block diagram of an example of a computing system.

FIG. 1B is a block diagram of an example of a processing device of a computing system.

FIG. 2A is a block diagram of topology of connections of an example of a computing system.

FIG. 2B is a block diagram of topology of connections of another example of a computing system.

FIG. 3A is a block diagram of an example of a cluster of a computing device.

FIG. 3B is a block diagram of an example of a super cluster of a computing device.

FIG. 4 is a block diagram of an example of a processing engine of a cluster.

FIG. 5 is a block diagram of an example of a packet used to address a computing resource of a computing system.

FIG. 6 is a flow diagram showing an example of a process of addressing a computing resource of a computing system using a packet.

FIG. 7A shows multiple clock domains within a super cluster.

FIG. 7B shows multiple clock domains within a computing device.

FIG. 8 shows an example of an asynchronous communications interface between computing modules operating in different clock domains.

FIGS. 9A-9B show aspects of an asynchronous communications interface.

Certain illustrative aspects of the systems, apparatuses, and methods according to the disclosed technologies are described herein in connection with the following description and the accompanying figures. These aspects are, however, indicative of but a few of the various ways in which the principles of the disclosed technologies may be employed and the disclosed technologies are intended to include all such aspects and their equivalents. Other advantages and novel features of the disclosed technologies may become apparent from the following detailed description when considered in conjunction with the figures.

### DETAILED DESCRIPTION

Technologies are described that can be used in a computing system including a plurality of computing resources that operate in different clock domains. A data transmitting computing resource that operates in a first clock domain of the computing system performs, in accordance with an asynchronous communications interface described herein, a data transfer to a data receiving computing resource that operates in a second clock domain of the computing system, in the following manner. The data transmitting computing resource places data corresponding to the data transfer on a parallel data channel including a plurality of data lines connecting the data transmitting computing resource and the data receiving computing resource. Here, at least some of the plurality of data lines of the parallel data channel have different effective physical lengths, such that a time difference between a valid state of a data bit placed on the effectively longest data line from among the plurality of data lines and a valid state of a data bit placed on the effectively shortest data line from among the plurality of data lines corresponds to a maximum delay. The data transmitting computing resource then waits a predetermined amount of time, after the placing of the data corresponding to the data transfer on the parallel data channel, where the predetermined amount of time is larger than or equal to the maximum delay. And, after waiting the predetermined amount of time, the data transmitting computing resource notifies the data receiving computing resource that the data placed on the parallel data channel are valid. In response to receiving the notification that the data placed on the parallel data channel are valid, the data receiving computing resource captures the data placed on the parallel data channel. The foregoing operations can be repeated for performing additional data transfers, e.g., to transmit a data packet between the data transmitting and data receiving computing resources operating asynchronously on different clock domains.

Although the disclosed asynchronous communications interface can be used in any computer system with computing resources that operate in different clock domains, implementations of the asynchronous communications interface will be described in detail below in the context of a computing system in which computing resources of the computing system communicate based on a network on a chip architecture. Structural aspects and functional aspects of such a computing system and of its computing resources are described first.

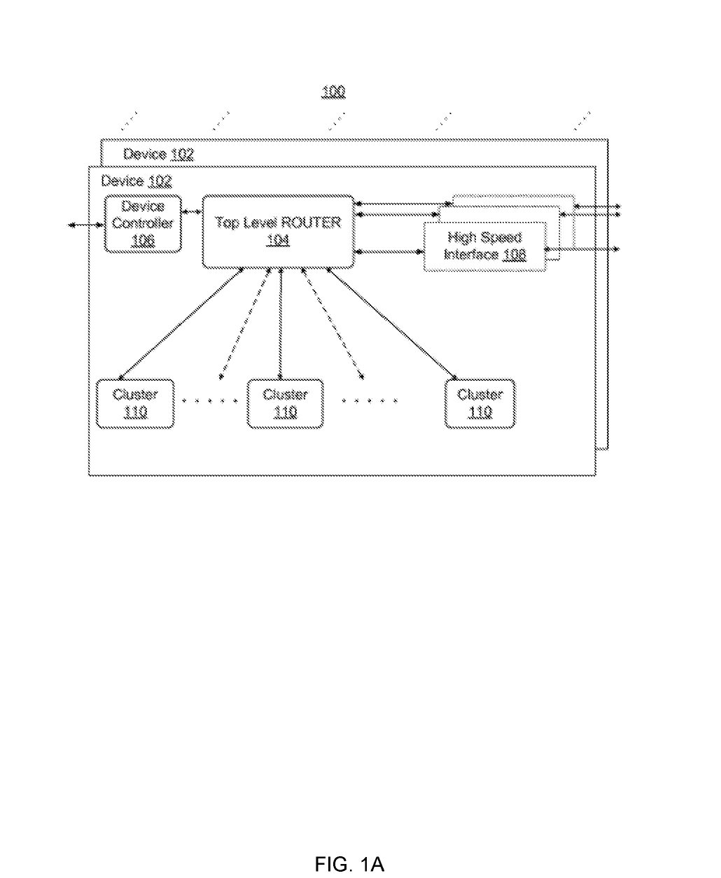

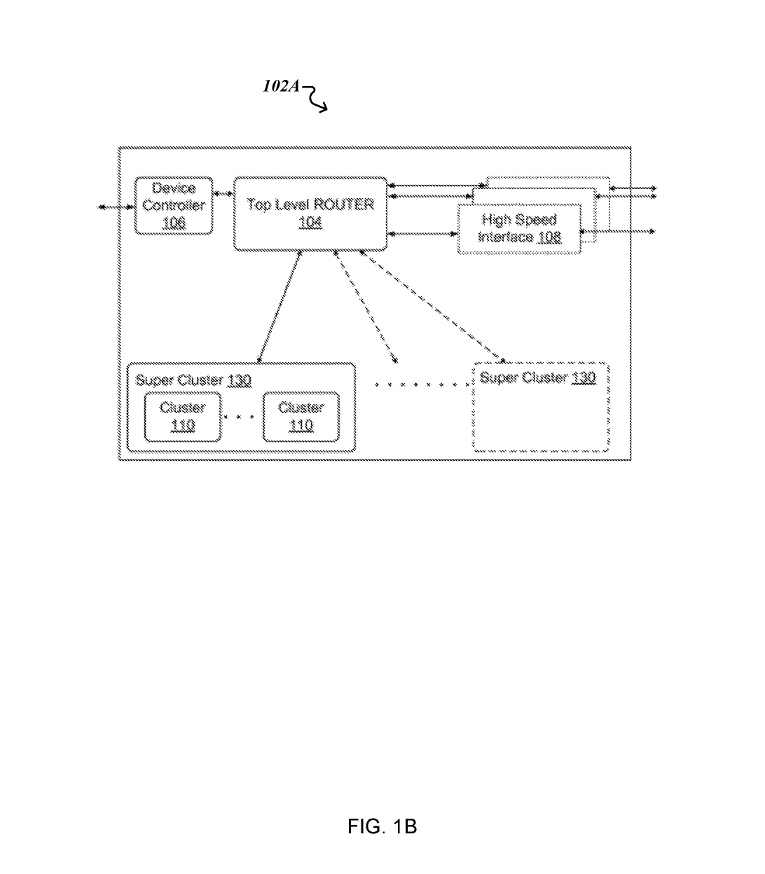

FIG. 1A shows an exemplary computing system 100 that includes at least one processing device 102. A typical computing system 100, however, may include a plurality of processing devices 102. In some implementations, each processing device 102, which may also be referred to as device 102, includes a router 104, a device controller 106, a plurality of high speed interfaces 108 and a plurality of clusters 110. The router 104 may also be referred to as a top level router or a level one router. Each cluster 110 includes a plurality of processing engines to provide computational capabilities for the computing system 100. In some implementations, the high speed interfaces 108 include communication ports to communicate data outside of the device 102, for example, to other devices 102 of the computing system 100 and/or interfaces to other computing systems. Unless specifically expressed otherwise, data as used herein may refer to both program code and pieces of information upon which the program code operates.

In some implementations, the processing device 102 includes 2, 4, 8, 16, 32 or another number of high speed interfaces 108. Each high speed interface 108 may implement a physical communication protocol. For example, each high speed interface 108 implements the media access control (MAC) protocol, and thus may have a unique MAC address associated with it. The physical communication may be implemented in a known communication technology, for example, Gigabit Ethernet, or any other existing or future-developed communication technology. For example, each high speed interface 108 implements bi-directional high-speed serial ports, such as 10 Giga bits per second (Gbps) serial ports. Two processing devices 102 implementing such high speed interfaces 108 may be directly coupled via one pair or multiple pairs of the high speed interfaces 108, with each pair including one high speed interface 108 on one processing device 102 and another high speed interface 108 on the other processing device 102.

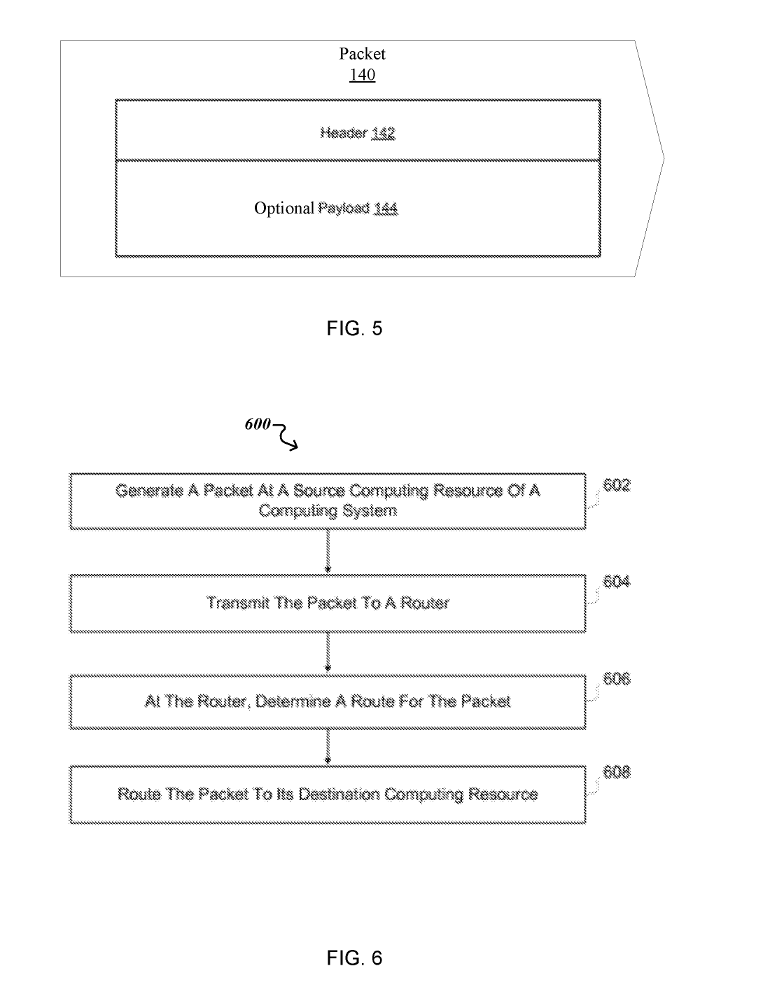

In accordance with network on a chip architecture, data communication between different computing resources of the computing system 100 is implemented using routable packets. The computing resources include device level resources such as a device controller 106, cluster level resources such as a cluster controller or cluster memory controller, and/or the processing engine level resources such as individual processing engines and/or individual processing engine memory controllers. An example of a routable packet 140 (or simply packet 140) is shown in FIG. 5. The packet 140 includes a header 142. Optionally, the packet also includes a payload 144. The header 142 includes a routable destination address for the packet 140. The router 104 may be a top-most router configured to route packets on each processing device 102. In some implementations, the router 104 is a programmable router. That is, the routing information used by the router 104 may be programmed and updated. In some cases, the router 104 is implemented using an address resolution table (ART) or Look-up table (LUT) to route any packet it receives on the high speed interfaces 108, or any of the internal interfaces interfacing the device controller 106 or clusters 110. For example, depending on the destination address, a packet 140 received from one cluster 110 may be routed to a different cluster 110 on the same processing device 102, or to a different processing device 102; and a packet 140 received from one high speed interface 108 may be routed to a cluster 110 on the processing device or to a different processing device 102.

In some implementations, the device controller 106 controls the operation of the processing device 102 from power on through power down. In some implementations, the device controller 106 includes a device controller processor, one or more registers and a device controller memory space. The device controller processor may be any existing or future-developed microcontroller. In some implementations, for example, an ARM® Cortex M0 microcontroller is used for its small footprint and low power consumption. In other implementations, a bigger and more powerful microcontroller is chosen if needed. The one or more registers include one to hold a device identifier (DEVID) for the processing device 102 after the processing device 102 is powered up. The DEVID is used to uniquely identify the processing device 102 in the computing system 100. In some implementations, the DEVID is loaded on system start from a non-volatile storage, for example, a non-volatile internal storage on the processing device 102 or a non-volatile external storage. The device controller memory space may include both read-only memory (ROM) and random access memory (RAM). In some implementations, the ROM may store bootloader code that during a system start is executed to initialize the processing device 102 and load the remainder of the boot code through a bus from outside of the device controller 106. In some implementations, the instructions for the device controller processor, also referred to as the firmware, reside in the RAM after they are loaded during the system start.

Here, the registers and device controller memory space of the device controller 106 are read and written to by computing resources of the computing system 100 using packets. That is, they are addressable using packets. As used herein, the term “memory” may refer to RAM, SRAM, DRAM, eDRAM, SDRAM, volatile memory, non-volatile memory, and/or other types of electronic memory. For example, the header of a packet includes a destination address such as DEVID:PADDR, of which the DEVID may identify the processing device 102 and the PADDR may be an address for a register of the device controller 106 or a memory location of the device controller memory space of a processing device 102. In some implementations, a packet directed to the device controller 106 has a packet operation code, which may be referred to as packet opcode or just opcode, to indicate what operation needs to be performed for the packet. For example, the packet operation code may indicate reading from or writing to the storage location pointed to by PADDR. It should be noted that the device controller 106 also sends packets in addition to receiving them. The packets sent by the device controller 106 may be self-initiated or in response to a received packet (e.g., a read request). Self-initiated packets include, for example, reporting status information, requesting data, etc.

In some implementations, a plurality of clusters 110 on a processing device 102 are grouped together. FIG. 1B shows a block diagram of another example of a processing device 102A of the computing system 100. The example processing device 102A is one particular embodiment of the processing device 102. Therefore, the processing device 102 referred to in the present disclosure may include any embodiments of the processing device 102, including the example processing device 102A. As shown on FIG. 1B, a plurality of clusters 110 may be grouped together to form a super cluster 130 and the example of processing device 102A may include a plurality of such super clusters 130. In some implementations, a processing device 102 includes 2, 4, 8, 16, 32 or another number of clusters 110, without further grouping the clusters 110 into super clusters. In other implementations, a processing device 102 may include 2, 4, 8, 16, 32 or another number of super clusters 130 and each super cluster 130 may comprise a plurality of clusters.

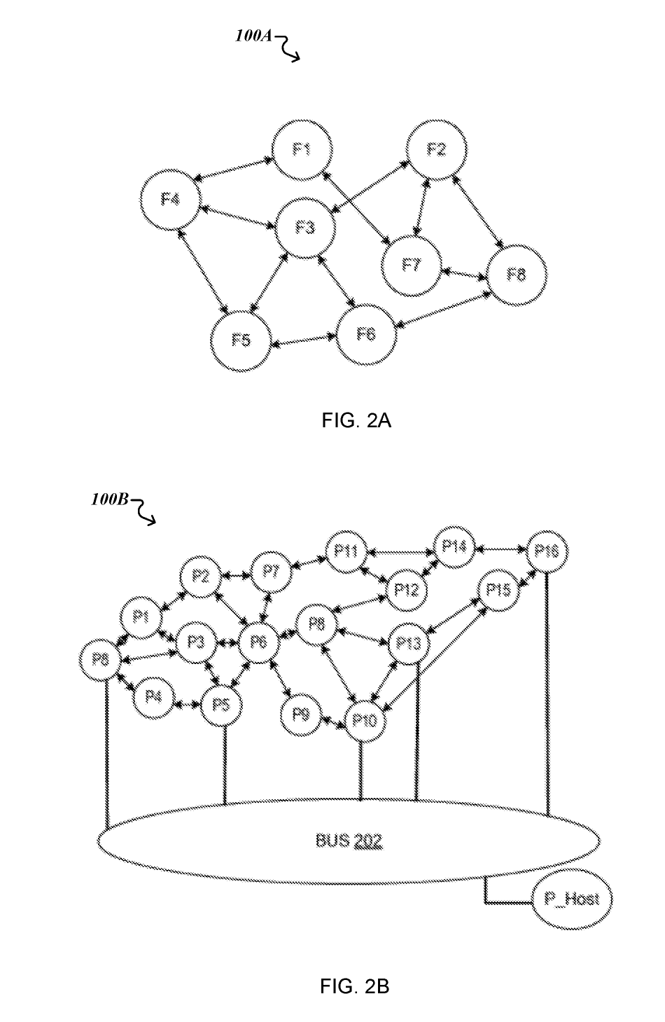

FIG. 2A shows a block diagram of an example of a computing system 100A. The computing system 100A may be one example implementation of the computing system 100 of FIG. 1A. The computing system 100A includes a plurality of processing devices 102 designated as F1, F2, F3, F4, F5, F6, F7 and F8. As shown in FIG. 2A, each processing device 102 is directly coupled to one or more other processing devices 102. For example, F4 is directly coupled to F1, F3 and F5; and F7 is directly coupled to F1, F2 and F8. Within computing system 100A, one of the processing devices 102 may function as a host for the whole computing system 100A. In some implementations, the host has a unique device ID that every processing devices 102 in the computing system 100A recognizes as the host. Any of the processing devices 102 may be designated as the host for the computing system 100A. For example, Fl may be designated as the host and the device ID for F1 is set as the unique device ID for the host.

In other implementations, the host is a computing device of a different type, such as a computer processor (for example, an ARM ® Cortex or Intel® x86 processor). Here, the host communicates with the rest of the system 100A through a communication interface, which represents itself to the rest of the system 100A as the host by having a device ID for the host.

The computing system 100A may implement any appropriate techniques to set the DEVIDs, including the unique DEVID for the host, to the respective processing devices 102 of the computing system 100A. In some implementations, the DEVIDs are stored in the ROM of the respective device controller 106 for each processing devices 102 and loaded into a register for the device controller 106 at power up. In other implementations, the DEVIDs are loaded from an external storage. Here, the assignments of DEVIDs may be performed offline (when there is no application running in the computing system 100A), and may be changed offline from time to time or as appropriate. Thus, the DEVIDs for one or more processing devices 102 may be different each time the computing system 100A initializes. Moreover, the DEVIDs stored in the registers for each device controller 106 may be changed at runtime. This runtime change is controlled by the host of the computing system 100A. For example, after the initialization of the computing system 100A, which loads the pre-configured DEVIDs from ROM or external storage, the host of the computing system 100A may reconfigure the computing system 100A and assign different DEVIDs to the processing devices 102 in the computing system 100A to overwrite the initial DEVIDs in the registers of the device controllers 106.

FIG. 2B is a block diagram of a topology of another example of a computing system 100B. The computing system 100B is another example implementation of the computing system 100 of FIG. 1 and includes a plurality of processing devices 102 (designated as P1 through P16 on FIG. 2B), a bus 202 and a processing device P_Host. Each processing device of P1 through P16 is directly coupled to another processing device of P1 through P16 by a direct link between them. At least one of the processing devices P1 through P16 is coupled to the bus 202. In the example shown in FIG. 2B, the processing devices P8, P5, P10, P13, P15 and P16 are coupled to the bus 202. Here, the processing device P_Host is coupled to the bus 202 and is designated as the host for the computing system 100B. In the computing system 100B, the host may be a computer processor (for example, an ARM® Cortex or Intel® x86 processor). The host communicates with the rest of the computing system 100B through a communication interface coupled to the bus and represents itself to the rest of the system 100B as the host by having a device ID for the host.

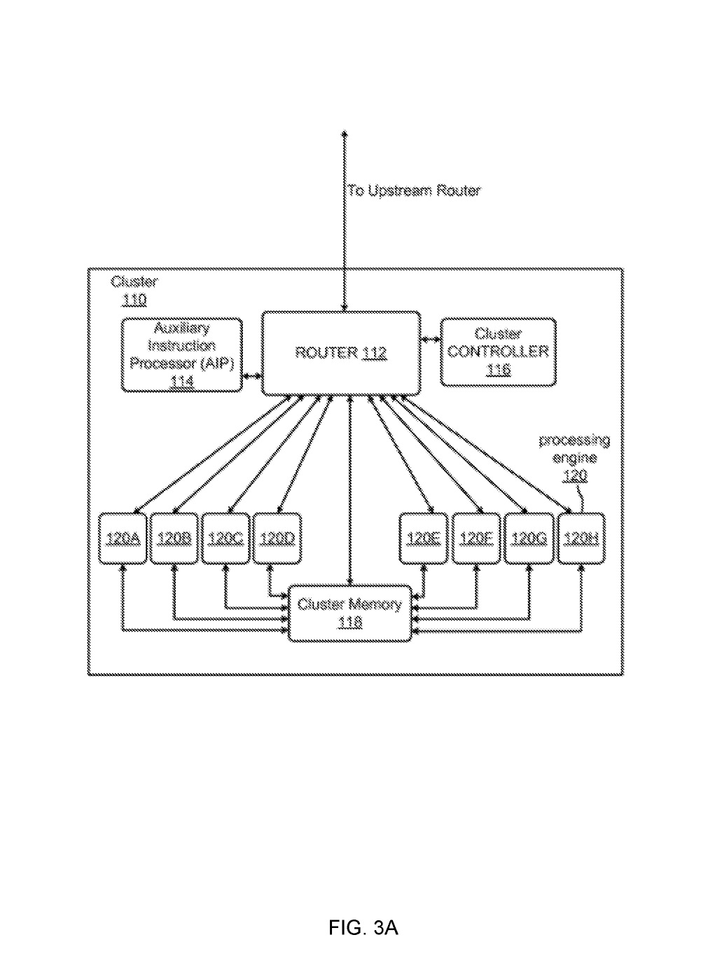

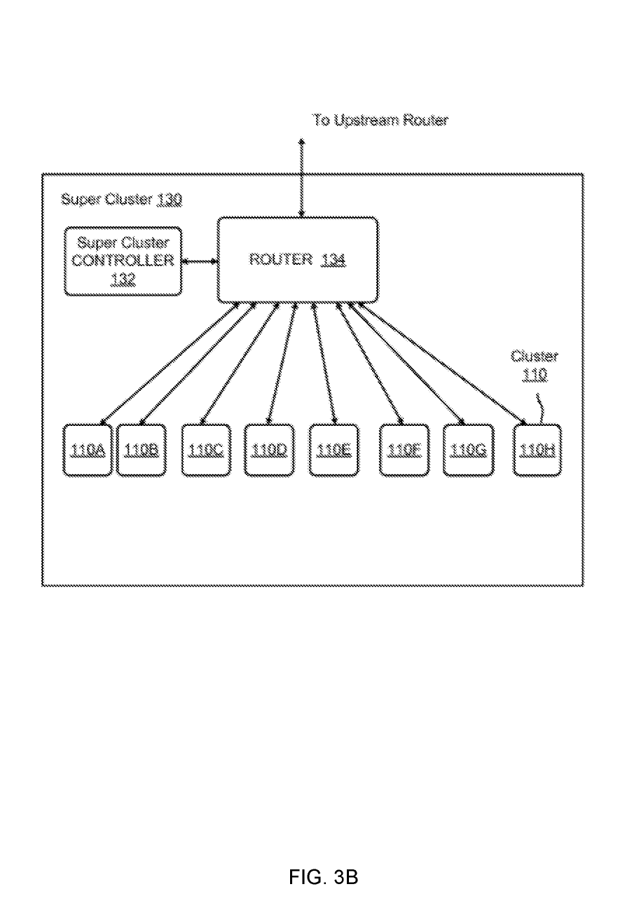

FIG. 3A shows a block diagram of an example of a cluster 110. The cluster 110 includes a router 112, a cluster controller 116, an auxiliary instruction processor (AIP) 114, a cluster memory 118 and a plurality of processing engines 120. The router 112 is coupled to an upstream router to provide interconnection between the upstream router and the cluster 110. The upstream router may be, for example, the router 104 of the processing device 102 if the cluster 110 is not part of a super cluster 130.

In accordance with network on a chip architecture, examples of operations to be performed by the router 112 include receiving a packet destined for a computing resource within the cluster 110 from outside the cluster 110 and/or transmitting a packet originating within the cluster 110 destined for a computing resource inside or outside the cluster 110. A computing resource within the cluster 110 may be, for example, the cluster memory 118 or any of the processing engines 120 within the cluster 110. A computing resource outside the cluster 110 may be, for example, a computing resource in another cluster 110 of the computer device 102, the device controller 106 of the processing device 102, or a computing resource on another processing device 102. In some implementations, the router 112 also transmits a packet to the router 104 even if the packet may target a resource within itself. In some cases, the router 104 implements a loopback path to send the packet back to the originating cluster 110 if the destination resource is within the cluster 110.

In some implementations, the cluster controller 116 sends packets, for example, as a response to a read request, or as unsolicited data sent by hardware for error or status report. The cluster controller 116 also receives packets, for example, packets with opcodes to read or write data. In some implementations, the cluster controller 116 is a microcontroller, for example, one of the ARM® Cortex-M microcontrollers and includes one or more cluster control registers (CCRs) that provide configuration and control of the cluster 110. In other implementations, instead of using a microcontroller, the cluster controller 116 is custom made to implement any functionalities for handling packets and controlling operation of the router 112. Here, the functionalities may be referred to as custom logic and may be implemented, for example, by FPGA or other specialized circuitry. Regardless of whether it is a microcontroller or implemented by custom logic, the cluster controller 116 may implement a fixed-purpose state machine encapsulating packets and memory access to the CCRs.

In some implementations, each cluster memory 118 is part of the overall addressable memory of the computing system 100. That is, the addressable memory of the computing system 100 includes the cluster memories 118 of all clusters of all devices 102 of the computing system 100. The cluster memory 118 is a part of the main memory shared by the computing system 100. In some implementations, any memory location within the cluster memory 118 may be addressed by any processing engine within the computing system 100 by a physical address. In some implementations, the physical address is a combination of the DEVID, a cluster identifier (CLSID) and a physical address location (PADDR) within the cluster memory 118. As such, the physical address is formed as a string of bits, e.g., DEVID:CLSID:PADDR. The DEVID may be associated with the device controller 106 as described above and the CLSID may be a unique identifier to uniquely identify the cluster 110 within the local processing device 102. It should be noted that in at least some implementations, each register of the cluster controller 116 also be assigned a physical address (PADDR). Therefore, the physical address DEVID:CLSID:PADDR may also be used to address a register of the cluster controller 116, in which PADDR may be an address assigned to the register of the cluster controller 116.

In some other implementations, any memory location within the cluster memory 118 is addressed by any processing engine within the computing system 100 by a virtual address. The virtual address may be a combination of a DEVID, a CLSID and a virtual address location (ADDR). As such, the virtual address is formed as a string of bits, e.g., DEVID:CLSID:ADDR. The DEVID and CLSID in the virtual address may be the same as in the physical addresses.

In some cases, the width of ADDR is specified by system configuration. For example, the width of ADDR is loaded into a storage location convenient to the cluster memory 118 during system start and/or changed from time to time when the computing system 100 performs a system configuration. In some implementations, to convert the virtual address to a physical address, the value of ADDR is added to a base physical address value (BASE). The BASE may also be specified by system configuration as the width of ADDR and stored in a location convenient to a memory controller of the cluster memory 118. In one example, the width of ADDR is stored in a first register and the BASE is stored in a second register in the memory controller. Thus, the virtual address DEVID:CLSID:ADDR is converted to a physical address as DEVID:CLSID:ADDR+BASE. Note that the result of ADDR+BASE has the same width as the target physical address.

The address in the computing system 100 may be 8 bits, 16 bits, 32 bits, 64 bits, or any other number of bits wide. In some implementations, the address is 32 bits wide. The DEVID may be 10, 15, 20, 25 or any other number of bits wide. The width of the DEVID is chosen based on the size of the computing system 100, for example, how many processing devices 102 the computing system 100 has or is designed to have. In some implementations, the DEVID is 20 bits wide and the computing system 100 using this width of DEVID contains up to 2²⁰ processing devices 102. The width of the CLSID is chosen based on how many clusters 110 the processing device 102 is designed to have. For example, the CLSID may be 3, 4, 5, 6, 7, 8 bits or any other number of bits wide. In some implementations, the CLSID is 5 bits wide and the processing device 102 using this width of CLSID contains up to 2⁵ clusters. The width of the PADDR for the cluster level may be 20, 30 or any other number of bits. For example, the PADDR for the cluster level is 27 bits and the cluster 110 using this width of PADDR contains up to 2²⁷ memory locations and/or addressable registers. Therefore, in some implementations, if the DEVID is 20 bits wide, CLSID is 5 bits and PADDR has a width of 27 bits, then a physical address DEVID:CLSID:PADDR or DEVID:CLSID:ADDR+BASE is 52 bits.

For performing the virtual to physical memory conversion, the first register (ADDR register) may have 4, 5, 6, 7 bits or any other number of bits. In some implementations, the first register is 5 bits wide. If the value of the 5 bits register is four (4), the width of ADDR is 4 bits; and if the value of 5 bits register is eight (8), the width of ADDR will be 8 bits. Regardless of ADDR being 4 bits or 8 bits wide, if the PADDR for the cluster level is 27 bits, then BASE is 27 bits, and the result of ADDR+BASE still is a 27 bits physical address within the cluster memory 118.

In the example illustrated in FIG. 3A, a cluster 110 includes one cluster memory 118. In other examples, a cluster 110 includes a plurality of cluster memories 118 that each includes a memory controller and a plurality of memory banks, respectively. Moreover, in yet another example, a cluster 110 includes a plurality of cluster memories 118 and these cluster memories 118 are connected together via a router that are downstream of the router 112.

The AIP 114 is a special processing engine shared by all processing engines 120 of one cluster 110. In some implementations, the AIP 114 is implemented as a coprocessor to the processing engines 120. For example, the AIP 114 implements less commonly used instructions such as some floating point arithmetic, including but not limited to, one or more of addition, subtraction, multiplication, division and square root, etc. In the example shown in FIG. 3A, the AIP 114 is coupled to the router 112 directly and is configured to send and receive packets via the router 112. As a coprocessor to the processing engines 120 within the same cluster 110, although not shown in FIG. 3A, the AIP 114 may also be coupled to each processing engines 120 within the same cluster 110 directly. In other implementations, a bus shared by all the processing engines 120 within the same cluster 110 is used for communication between the AIP 114 and all the processing engines 120 within the same cluster 110. In some other implementations, a multiplexer is used to control access to the bus shared by all the processing engines 120 within the same cluster 110 for communication with the AIP 114. In yet other implementations, a multiplexer is used to control communication between the AIP 114 and all the processing engines 120 within the same cluster 110.

The grouping of the processing engines 120 on a computing device 102 may have a hierarchy with multiple levels. For example, multiple clusters 110 are grouped together to form a super cluster. FIG. 3B is a block diagram of an example of a super cluster 130 of the computing device 102. In the example shown in FIG. 3B, a plurality of clusters 110A through 110H are grouped into the super cluster 130. Although 8 clusters are shown in the super cluster 130 on FIG. 3B, the super cluster 130 may include 2, 4, 8, 16, 32 or another number of clusters 110. The super cluster 130 includes a router 134 and a super cluster controller 132, in addition to the plurality of clusters 110. The router 134 is configured to route packets among the clusters 110 and the super cluster controller 132 within the super cluster 130, and to and from computing resources outside the super cluster 130 via a link to an upstream router. In implementations in which the super cluster 130 is used in a processing device 102A, the upstream router for the router 134 is the top level router 104 of the processing device 102A and the router 134 is an upstream router for the router 112 within the cluster 110. In some implementations, the super cluster controller 132 may be configured to implement CCRs, receive and send packets, and implement a fixed-purpose state machine encapsulating packets and memory access to the CCRs. In some cases, the super cluster controller 132 is implemented similar to the way the cluster controller 116 is implemented in a cluster 110. In other implementations, the super cluster 130 is implemented with just the router 134 and does not have a super cluster controller 132.

As noted above, a cluster 110 may include 2, 4, 8, 16, 32 or another number of processing engines 120. FIG. 3A shows an example of a plurality of processing engines 120 that have been grouped into a cluster 110, and FIG. 3B shows an example of a plurality of clusters 110 that have been grouped into a super cluster 130. Grouping of processing engines is not limited to clusters or super clusters. In some implementations, more than two levels of grouping is implemented and each level has its own router and controller.

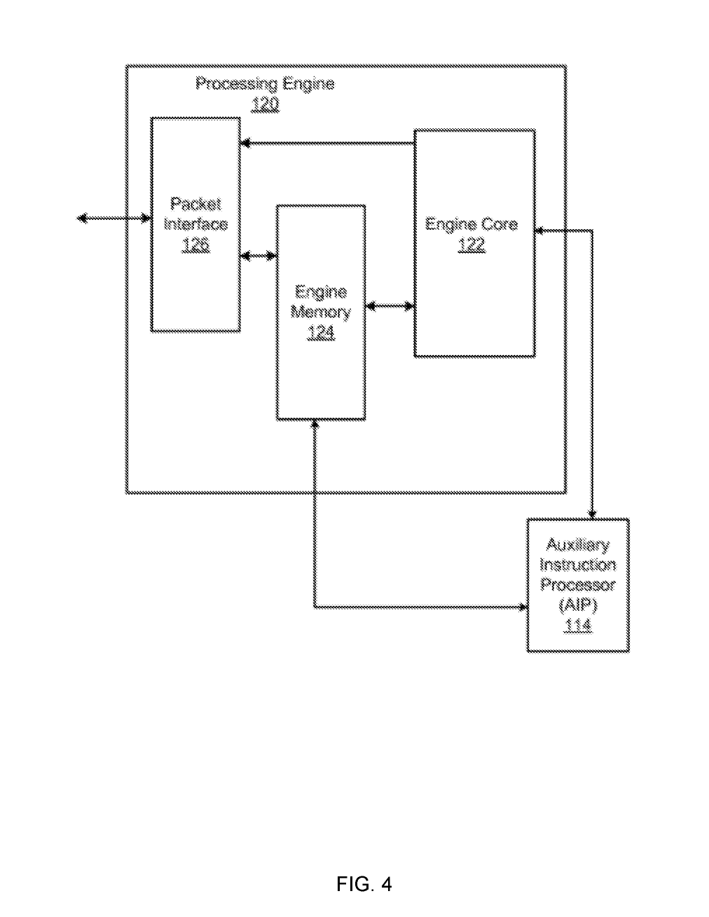

FIG. 4 shows a block diagram of an example of a processing engine 120 of a processing device 102. In the example shown in FIG. 4, the processing engine 120 includes an engine core 122, an engine memory 124 and a packet interface 126. Here, the processing engine 120 is directly coupled to an AIP 114. As described above, the AIP 114 may be shared by all processing engines 120 within a cluster 110. In some implementations, the processing core 122 is a central processing unit (CPU) with an instruction set and implements some or all features of modern CPUs, such as, for example, a multi-stage instruction pipeline, one or more arithmetic logic units (ALUs), one or more floating point units (FPUs) or any other CPU technology. The instruction set includes one instruction set for the ALU to perform arithmetic and logic operations, and another instruction set for the FPU to perform floating point operations. In some cases, the FPU is a completely separate execution unit containing a multi-stage, single-precision floating point pipeline. When an FPU instruction reaches the instruction pipeline of the processing engine 120, the instruction and its source operand(s) are dispatched to the FPU.

The instructions of the instruction set may implement the arithmetic and logic operations and the floating point operations, such as those in the INTEL® x86 instruction set, using a syntax similar or different from the x86 instructions. In some implementations, the instruction set includes customized instructions. For example, one or more instructions are implemented according to the features of the computing system 100 and in accordance with network on a chip architecture. In one example, one or more instructions cause the processing engine executing the instructions to generate packets directly with system wide addressing. In another example, one or more instructions have a memory address located anywhere in the computing system 100 as an operand. In the latter example, a memory controller of the processing engine executing the instruction generates packets according to the memory address being accessed.

The engine memory 124 includes a program memory, a register file including one or more general purpose registers, one or more special registers and one or more events registers. In some implementations, the program memory is a physical memory for storing instructions to be executed by the processing core 122 and data to be operated upon by the instructions. In some cases, portions of the program memory are disabled and powered down for energy savings. For example, a top half or a bottom half of the program memory is disabled to save energy when executing a program small enough that half or less of the storage may be needed. The size of the program memory may be 1 thousand (1K), 2K, 3K, 4K, or any other number of storage units. The register file may include 128, 256, 512, 1024, or any other number of storage units. In some implementations, the storage unit is 32-bit wide, which may be referred to as a longword, and the program memory includes 2K 32-bit longwords and the register file includes 256 32-bit registers.

In some implementations, the register file includes one or more general purpose registers and special registers for the processing core 122. The general purpose registers serve functions that are similar or identical to the general purpose registers of an x86 architecture CPU. The special registers are used for configuration, control and/or status, for instance. Examples of special registers include one or more of the following registers: a next program counter, which may be used to point to the program memory address where the next instruction to be executed by the processing core 122 is stored; and a device identifier (DEVID) register storing the DEVID of the processing device 102.

In some implementations, the register file is implemented in two banks—one bank for odd addresses and one bank for even addresses—to permit multiple fast accesses during operand fetching and storing. The even and odd banks are selected based on the least-significant bit of the register address if the computing system 100 is implemented in little endian or on the most-significant bit of the register address if the computing system 100 is implemented in big-endian.

In some implementations, the engine memory 124 is part of the addressable memory space of the computing system 100. That is, any storage location of the program memory, any general purpose register of the register file, any special register of the plurality of special registers and any event register of the plurality of events registers is assigned a memory address PADDR. Each processing engine 120 on a processing device 102 is assigned an engine identifier (ENGINE ID), therefore, to access the engine memory 124, any addressable location of the engine memory 124 may be addressed by DEVID:CLSID:ENGINE ID: PADDR. In some cases, a packet addressed to an engine level memory location includes an address formed as DEVID:CLSID:ENGINE ID: EVENTS:PADDR, in which EVENTS is one or more bits to set event flags in the destination processing engine 120. It should be noted that when the address is formed as such, the events need not form part of the physical address, which is still DEVID:CLSID:ENGINE ID:PADDR. In this form, the events bits may identify one or more event registers to be set but these events bits are separate from the physical address being accessed.

In accordance with network on a chip architecture, the packet interface 126 includes a communication port for communicating packets of data. The communication port is coupled to the router 112 and the cluster memory 118 of the local cluster. For any received packets, the packet interface 126 directly passes them through to the engine memory 124. In some cases, a processing device 102 implements two mechanisms to send a data packet to a processing engine 120. A first mechanism uses a data packet with a read or write packet opcode. This data packet is delivered to the packet interface 126 and handled by the packet interface 126 according to the packet opcode. Here, the packet interface 126 includes a buffer to hold a plurality of storage units, for example, 1K, 2K, 4K, or 8K or any other number. In a second mechanism, the engine memory 124 further includes a register region to provide a write-only, inbound data interface, which may be referred to a mailbox. In some implementations, the mailbox includes two storage units that each can hold one packet at a time. Here, the processing engine 120 has an event flag, which is set when a packet has arrived at the mailbox to alert the processing engine 120 to retrieve and process the arrived packet. While this packet is being processed, another packet may be received in the other storage unit, but any subsequent packets are buffered at the sender, for example, the router 112 or the cluster memory 118, or any intermediate buffers.

In various implementations, data request and delivery between different computing resources of the computing system 100 is implemented by packets. FIG. 5 illustrates a block diagram of an example of a packet 140 in accordance with network on a chip architecture. As shown in FIG. 5, the packet 140 includes a header 142 and an optional payload 144. The header 142 includes a single address field, a packet opcode (POP) field and a size field. The single address field indicates the address of the destination computing resource of the packet, which may be, for example, an address at a device controller level such as DEVID:PADDR, an address at a cluster level such as a physical address DEVID:CLSID:PADDR or a virtual address DEVID:CLSID:ADDR, or an address at a processing engine level such as DEVID:CLSID:ENGINE ID:PADDR or DEVID:CLSID:ENGINE ID:EVENTS:PADDR. The POP field may include a code to indicate an operation to be performed by the destination computing resource. Exemplary operations in the POP field may include read (to read data from the destination) and write (to write data (e.g., in the payload 144) to the destination).

In some implementations, examples of operations in the POP field further include bulk data transfer. For example, certain computing resources implement a direct memory access (DMA) feature. Examples of computing resources that implement DMA may include a cluster memory controller of each cluster memory 118, a memory controller of each engine memory 124, and a memory controller of each device controller 106. Any computing resource that implements the DMA may perform bulk data transfer to another computing resource using packets with a packet opcode for bulk data transfer.

In addition to bulk data transfer, the examples of operations in the POP field further include transmission of unsolicited data. For example, any computing resource may generate a status report or incur an error during operation, the status or error is reported to a destination using a packet with a packet opcode indicating that the payload 144 contains the source computing resource and the status or error data.

The POP field may be 2, 3, 4, 5 or any other number of bits wide. In some implementations, the width of the POP field is selected depending on the number of operations defined for packets in the computing system 100. Also, in some embodiments, a packet opcode value can have different meaning based on the type of the destination computing resource that receives it. For example, for a three-bit POP field, a value 001 may be defined as a read operation for a processing engine 120 but a write operation for a cluster memory 118.

In some implementations, the header 142 further includes an addressing mode field and an addressing level field. Here, the addressing mode field contains a value to indicate whether the single address field contains a physical address or a virtual address that may need to be converted to a physical address at a destination. Further here, the addressing level field contains a value to indicate whether the destination is at a device, cluster memory or processing engine level.

The payload 144 of the packet 140 is optional. If a particular packet 140 does not include a payload 144, the size field of the header 142 has a value of zero. In some implementations, the payload 144 of the packet 140 contains a return address. For example, if a packet is a read request, the return address for any data to be read may be contained in the payload 144.

FIG. 6 is a flow diagram showing an example of a process 600 of addressing a computing resource of a computing system using a packet in accordance with network on a chip architecture. An implementation of the computing system 100 may have one or more processing devices 102 configured to execute some or all of the operations of the process 600 in response to instructions stored electronically on an electronic storage medium. The one or more processing devices 102 include one or more devices configured through hardware, firmware, and/or software to execute one or more of the operations of the process 600.

The process 600 may start with block 602, at which a packet is generated at a source computing resource of the computing system 100. The source computing resource may be, for example, a device controller 106, a cluster controller 118, a super cluster controller 132 if a super cluster is implemented, an AIP 114, a memory controller for a cluster memory 118, or a processing engine 120. The generated packet may be the packet 140 described above in connection with FIG. 5. From block 602, the exemplary process 600 may continue to the block 604, where the packet is transmitted to an appropriate router based on the source computing resource that generated the packet. For example, if the source computing resource is a device controller 106, the generated packet is transmitted to a top level router 104 of the local processing device 102; if the source computing resource is a cluster controller 116, the generated packet is transmitted to a router 112 of the local cluster 110; if the source computing resource is a memory controller of the cluster memory 118, the generated packet is transmitted to a router 112 of the local cluster 110, or a router downstream of the router 112 if there are multiple cluster memories 118 coupled together by the router downstream of the router 112; and if the source computing resource is a processing engine 120, the generated packet is transmitted to a router of the local cluster 110 if the destination is outside the local cluster and to a memory controller of the cluster memory 118 of the local cluster 110 if the destination is within the local cluster.

At block 606, a route for the generated packet is determined at the router. As described above, the generated packet includes a header that includes a single destination address. The single destination address is any addressable location of a uniform memory space of the computing system 100. The uniform memory space is an addressable space that covers all memories and registers for each device controller, cluster controller, super cluster controller if a super cluster is implemented, cluster memory and processing engine of the computing system 100. In some cases, the addressable location is part of a destination computing resource of the computing system 100. The destination computing resource may be, for example, another device controller 106, another cluster controller 118, a memory controller for another cluster memory 118, or another processing engine 120, which is different from the source computing resource. The router that received the generated packet determines the route for the generated packet based on the single destination address. At block 608, the generated packet is routed to its destination computing resource.

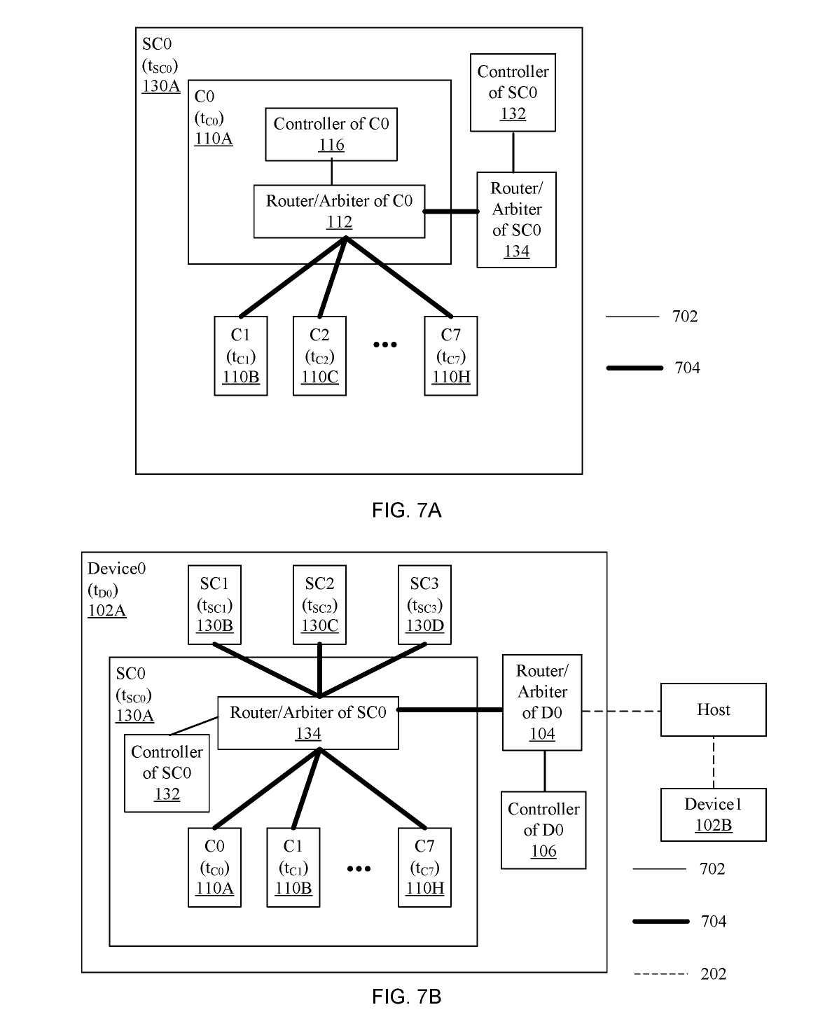

FIG. 7A shows a super cluster 130A, like the one described in detail above in connection with FIG. 3B, that has multiple clock domains associated with the super cluster. The super cluster 130A can be one of the multiple super clusters of the computing device 102A illustrated in FIG. 1B, for instance. As such, the super cluster 130 includes a super cluster controller 132, a super cluster router 134 and a plurality of clusters, e.g., first cluster C0 110A, second cluster C1 110B, and so on. Moreover, each of the plurality of clusters of the super cluster 130A includes a cluster router 112, a controller 116 and a plurality of processing engines 120 (not shown in FIG. 7A). FIG. 7B shows a device 102A, like the one described in detail above in connection with FIG. 1B, that has multiple clock domains associated with the device. The device 102A can be one of multiple devices of a computing system 102A illustrated in FIG. 2B, for instance, in which the devices communicate with a host and each other using a bus 202 (e.g., a high speed serial interface 108). As such, the device 102A includes a device router 104, a device controller 106 and a plurality of super clusters, e.g., first super cluster SC0 130A, second super cluster SC1 130B, and so on. Here, the first super cluster SC0 130A can be the super cluster 130A illustrated in FIG. 7A.

Referring now to both FIGS. 7A-7B, a device clock domain t_{D0} includes a set of computing resources of the device 102A (e.g., the device router 104 and the device controller 106) that are operated synchronously, at the device level, by using a common device clock. In this manner, data transfers between computing resources in the device clock domain t_{D0} are carried out using a synchronous communication interface 702, denoted in FIGS. 7A-7B by a thin line. Each super cluster clock domain t_{SCi}, where i=0 . . . 3, includes a set of computing resources of the respective super cluster 130A, 130B, 130C and 130D (e.g., the super cluster controller 132 and the super cluster router 134) that are operated synchronously, at the super cluster level, by using a respective common super cluster clock. In this manner, data transfers between computing resources in the super cluster clock domain t_{SC0} are carried out using the synchronous communication interface 702. Each cluster clock domain t_{Cj}, where j=0 . . . 7, includes a set of computing resources of the respective cluster 110A, 110B, . . . , or 110H (e.g., the cluster router 112, the cluster controller 116 and the respective plurality of processing engines 120 of the cluster) that are operated synchronously, at the cluster level, by using a respective common cluster clock. In this manner, data transfers between computing resources in each cluster clock domain t_{Cj} are carried out using the synchronous communication interface 702.

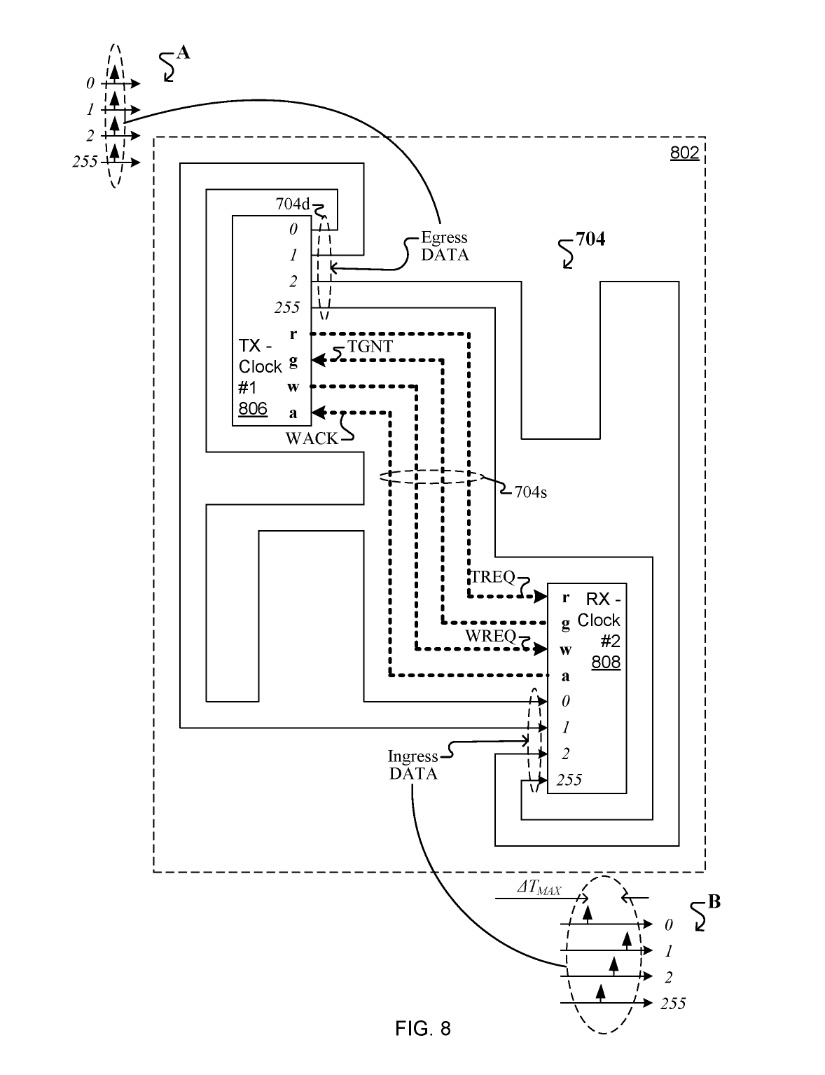

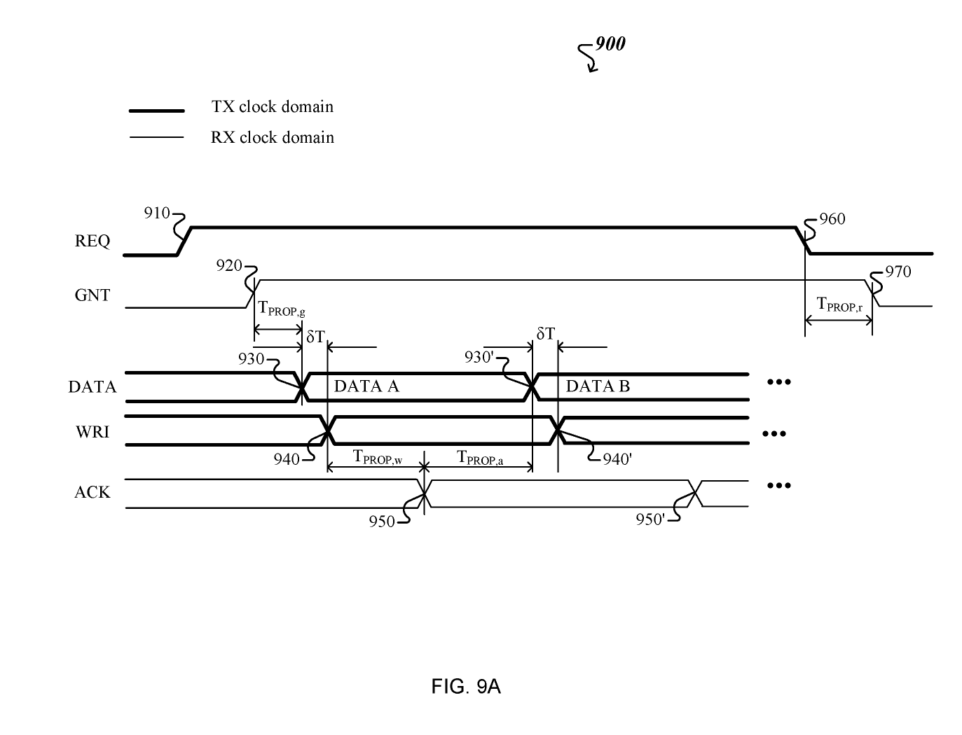

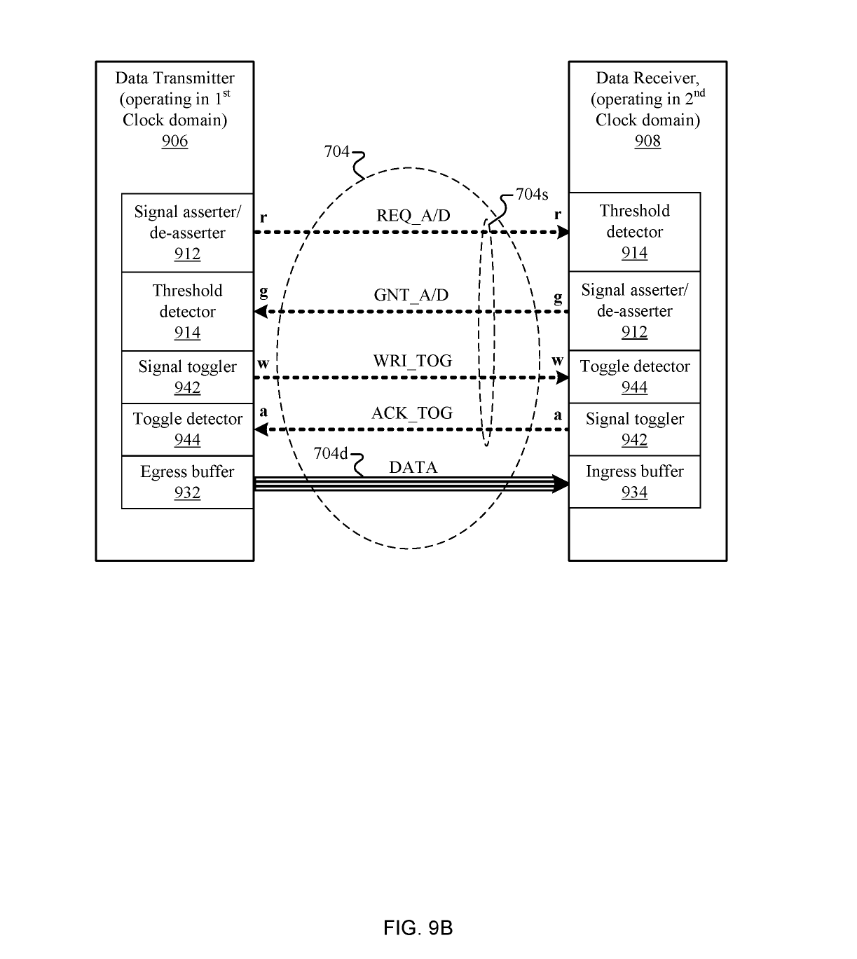

Note that the respective clocks of the device clock domain t_{D0}, super cluster clock domains t_{SC0}, . . . , t_{SC3}, and cluster clock domains t_{C0}, . . . , t_{C7} are different from each other. In some cases, respective clocks of different clock domains have different frequencies, in other cases respective clocks of different clock domains may have the same frequency but different skews. As such, data transfers between computing resources in the device clock domain t_{D0} and computing resources in each of the super cluster clock domains t_{SCi} of the device 102A are carried out using an asynchronous communication interface 704, denoted in FIGS. 7A-7B by a bold line and described in detail below in connection with FIGS. 8, 9A-9B.

Further, (i) data transfers between computing resources in the different cluster clock domains t_{Cj} and t_{Ck}, where j≠k and j,k=0 . . . 7, within super cluster 130A, and (ii) data transfers between computing resources of a cluster clock domain t_{C0} within the cluster 110A and computing resources of the super cluster 130A that includes the cluster 110A, are carried out using the asynchronous communication interface 704. In this manner, in the example illustrated in FIG. 7A, a cluster router 112 (e.g., of cluster C0) in an associated cluster clock domain (e.g., t_{C0}) can use the asynchronous interface 704 to communicate with (i) a super cluster router 134 in the super cluster clock domain t_{SC0} and (ii) seven cluster routers (e.g., of clusters C1, . . . , C7) in respective cluster clock domains (e.g., t_{C1}, . . . , t_{C7}).

Furthermore, (i) data transfers between computing resources in a super cluster clock domain t_{SC0} and computing resources in each of the cluster clock domains t_{Cj} within the super cluster 130A, (ii) data transfers between computing resources in the different super cluster clock domains t_{SCi} and t_{SCk}, where i≠k and i,k=0 . . . 3, within the device 102A that includes the super cluster 130A, and (iii) data transfers between computing resources of the super cluster clock domain t_{SC0} and computing resources of the device 102A, are carried out using the asynchronous communication interface 704. In this manner, in the example illustrated in FIG. 7B, a super cluster router 134 (e.g., of super cluster 130A) in an associated clock domain (e.g., t_{SC0}) can use the asynchronous interface 704 to communicate with (i) a device router 104 in the device clock domain t_{D0}, (ii) three other super cluster routers (e.g., of super clusters SC1, SC2 and SC3) in respective super cluster clock domains (e.g., t_{SC1}, t_{SC2}, t_{SC3}), and (iii) eight cluster routers (e.g., of clusters C0, . . . , C7) in respective cluster clock domains (e.g., of clusters t_{C0}, . . . , t_{C7}).

FIG. 8 shows an implementation of an asynchronous communication interface 704 between a data transmitter TX 806 and a data receiver RX 808 that operate in different clock domains. Here, the data transmitter 806 is operated in accordance with a first clock and the data receiver 808 is operated in accordance with a second clock different from the first clock, and both the data transmitter and the data receiver are computing resources of a chip device 802. In some implementations, the chip device 802 can be similar to network on a chip devices 102, 102A, etc., described above in this specification. For example, in reference with FIG. 7A, data transmitter 806 can be part of cluster router/arbiter 112 of cluster 110A operating in cluster clock domain t_{C0} and data receiver 808 can be part of super cluster router/arbiter 134 of cluster 130A operating in super cluster clock domain t_{SC0}. As another example, in reference with FIG. 7B, data transmitter 806 can be part of super cluster router/arbiter 134 of super cluster 130A operating in super cluster clock domain t_{SC0} and data receiver 808 can be part of device router/arbiter 104 of device 102A operating in device clock domain t_{D0}.

As part of the asynchronous communication interface 704, the data transmitter 806 and the data receiver 808 are coupled together through a parallel data channel 704d and a parallel signal channel 704s. The parallel data channel 704d, also referred to as a broadband data connector, includes a plurality of data lines, e.g., 256 data lines represented in FIG. 8 by solid lines, that are electrical conductors connected between corresponding output (or egress) data ports 0, 1, 2, . . . , 255 of the data transmitter 806 and input (or ingress) data ports 0, 1, 2, . . . , 255 of the data receiver 808. Note that at least some of the plurality of data lines of the parallel data channel 704d have different effective lengths, because (i) some of the data lines may be routed along paths of different physical length disposed in a given metallization layer of the chip device 802 (as shown in in FIG. 8), and (ii) some other of the data lines may be routed along paths disposed in different metallization layers, in which conductance of the paths varies based on the metallization layer. The parallel signal channel 704s includes signal lines, represented by dotted lines in FIG. 8, that are electrical conductors connected between output signal ports “r”, “w” of the data transmitter 806 and respective input signal ports “r”, “w” of the data receiver 808, and between input signal ports “g”, “a” of the data transmitter and respective output signal ports “g”, “a” of the data receiver. In some implementations, a set of amplifiers (e.g., spaced apart by 200 μm) can be used along the data lines of the parallel data channel 704d and the signal lines of the parallel signal channel 704s to amplify respective signals provided there through. The asynchronous communication interface 704 shown in FIG. 8 can be used to perform data transfers from the data transmitter 806 to the data receiver 808 in the following manner.

For instance, the data transmitter 806 provides to the data receiver 808 a transmission request (denoted TREQ) to perform one or more data transfers to transmit a data packet from the data transmitter to the data receiver. The data packet to be transmitted in this example may be the packet 140 described above in connection with FIG. 5. The transmission request is provided by the data transmitter 806 at transmitter output port “r” on a dedicated request signal line of the parallel signal channel 704s and is received by the data receiver 808 at corresponding receiver input port “r”. In response to receiving the transmission request, an arbiter module of the data receiver 808 processes the transmission request based on whether the data receiver is currently receiving, or is scheduled to receive, data from one or more other transmitters. Once the arbiter module of the data receiver 808 determines that the transmission request received from the data transmitter 806 can be granted, the data receiver provides to the data transmitter a transmission grant (denoted TGNT) to notify the data transmitter that the transmission request has been granted. The transmission grant is provided by the data receiver 808 at receiver output port “g” on a dedicated grant signal line of the parallel signal channel 704s and is received by the data transmitter 806 at corresponding transmitter input port “g”.

In response to receiving the transmission grant, the data transmitter 806 places data, corresponding to a data transfer of the one or more data transfers, at at least some of egress ports 0, 1, 2, . . . , 225 on the parallel data channel 704d. For example, if a data packet to be transmitted from the data transmitter 806 to the data receiver 808 has 64 bits of data, then the data transmitter places the 64 bits of data at 64 egress ports from among the 256 egress ports on respective 64 data lines from among the 256 data lines of the parallel data channel 704d, for a single data transfer. As another example, if a data packet to be transmitted from the data transmitter 806 to the data receiver 808 has 256 bits of data, then the data transmitter 806 places the 256 bits of data at all of the 256 egress ports on respective all of the 256 data lines of the parallel data channel 704d, for a single data transfer. As yet another example, if a data packet to be transmitted from the data transmitter 806 to the data receiver 808 has 384 bits of data, then the data transmitter 806 places the first 256 bits of the 384 bits of data at all of the 256 egress ports on respective all of the 256 data lines of the parallel data channel 704d to be transmitted to the data receiver 808, for a first data transfer. And, the data transmitter 806 will later place the remaining 128 bits of the 384 bits of data at 128 egress ports from among the 256 egress ports on respective 128 data lines from among the 256 data lines of the parallel data channel, for a second data transfer.

Once the data has been placed on the parallel data channel 704d, the data transmitter 806 waits (pauses) for a predetermined amount of time. Note that although egress data placed on the parallel data channel 704d has all its data bits aligned in time, as shown in inset A of FIG. 8, because at least some of the data lines of the parallel data channel 704d have different effective lengths, propagation times of the data bits will be different over the data lines of the parallel data channel, such that the data bits of ingress data arrive at the data receiver 808 at different times, as shown in inset B of FIG. 8. Here, a data bit placed on the effectively shortest data line will be first to arrive at the data receiver 808, and a data bit placed on the effectively longest data line will be last to arrive at the data receiver, delayed by a maximum time ΔT_{MAX} relative the data bit that arrived first. Equivalently, a time difference between a valid state of a data bit placed on the effectively longest data line of the parallel data channel 704d and a valid state of a data bit placed on the effectively shortest data line of the parallel data channel corresponds to the maximum delay ΔT_{MAX}. For this reason, the predetermined amount of time that data transmitter 806 waits after placing the data on the parallel data channel 704d is larger than or equal to the maximum delay ΔT_{MAX}. Note that the predetermined amount of time associated with the asynchronous communications interface 704 can be up to 100 ps when the disclosed asynchronous communications interface is used in conjunction with a chip device 802 similar to the network on a chip devices 102, 102A described above in this specification.

After waiting the predetermined amount of time, the data transmitter 806 provides to the data receiver 808 a write request (denoted WREQ) to notify the data receiver that the data placed on the parallel data channel 704d are valid. The write request is provided by the data transmitter 806 at transmitter output port “w” on a dedicated write signal line of the parallel signal channel 704s and is received by the data receiver 808 at corresponding receiver input port “w”. Note that the data receiver 808 has been waiting for such a notification from the data transmitter 806 since it had provided the transmission grant. In response to receiving the write request, the data receiver 808 captures the ingress data from the parallel data channel 704d. Once the data receiver 808 captures the ingress data, the data receiver provides to the data transmitter 806 a write acknowledgment (denoted WACK) to notify the data transmitter that the data placed on the parallel data channel 704d has been captured. The write acknowledgment is provided by the data receiver 808 at receiver output port “a” on a dedicated acknowledgment signal line of the parallel signal channel 704s and is received by the data transmitter 806 at corresponding transmitter input port “a”.

After the receiving of the write acknowledgment, the data transmitter 806 determines whether one or more data transfers remain to be performed, in addition to the completed data transfer, to complete transmission of the data packet. In response to determining that at least a second data transfer remains to be performed, the data transmitter 806 places second data corresponding to the second data transfer on the parallel data channel 704d, and then waits the predetermined amount of time after the placing of the second data on the parallel data channel. After waiting the predetermined amount of time, the data transmitter 806 provides, to the data receiver 808 on the write signal line, a second write request (WREQ) to notify the data receiver that the second data placed on the parallel data channel 704d are valid. Moreover, after providing to the data transmitter 806 the write acknowledgement corresponding to capture of the first ingress data, the data receiver 808 waits to receive from the data transmitter the second write request to notify the data receiver that second ingress data are valid. In response to receiving the second write request, the data receiver 808 captures the second ingress data, then provides, to the data transmitter 806 on the acknowledgement signal line, a second write acknowledgment (WACK) to notify the data transmitter that the second data placed on the parallel data channel 704d has been captured. Additional data transfers can be iteratively performed using the asynchronous communication interface 704, as described above, until transmission of the data packet from the data transmitter 806 to the data receiver 808 is completed.

Alternatively, in response to determining that no additional data transfers remain to be performed to complete the transmission of the data packet, the data transmitter 806 provides to the data receiver 808 a completion request to indicate that the transmission of the data packet has been completed. The completion request is provided by the data transmitter 806 at the transmitter output port “r” on the dedicated request signal line of the parallel signal channel 704s and is received by the data receiver 808 at the corresponding receiver input port “r”. Moreover, in response to receiving the completion request, the arbiter module of the data receiver 808 determines that the current transmission grant for the data transmitter 806 is to be removed, and instructs the data receiver to provide a transmission denial to notify the data transmitter that the transmission grant has been removed. The transmission denial is provided by the data receiver 808 at the receiver output port “g” on the dedicated grant signal line of the parallel signal channel 704s and is received by the data transmitter 806 at the corresponding transmitter input port “g”.

FIG. 9A shows an example of a timing diagram 900 of the asynchronous communications interface 704. FIG. 9B shows an example of a data transmitter 906 that operates in a first clock domain and an example of a data receiver 908 that operates in a second clock domain different from the first clock domain, where the data transmitter uses the asynchronous communications interface 704, in accordance with the timing diagram 900, to transmit a data packet to the data receiver. The data packet to be transmitted in the examples illustrated in FIGS. 9A-9B may be the packet 140 described above in connection with FIG. 5. Here, the data packet includes DATA A, DATA B, etc., such that the data packet will be transmitted, in accordance with the asynchronous communications interface 704, using a sequence of data transfers corresponding to DATA A, DATA B, etc. For instance, the data transmitter 906 can be implemented as the data transmitter 806 described above in connection with FIG. 8. As such, the data transmitter 906 further includes an egress buffer 932 to store at least a portion of the data packet prior to its transmission to the data receiver 908. Similarly, the data receiver 908 can be implemented as the data receiver 808 described above in connection with FIG. 8. As such, the data receiver 908 further includes an ingress buffer 934 to store at least a portion of the data packet transmitted from the data transmitter 906. Further, the data transmitter 806 includes a signal asserter/de-asserter circuit 912 coupled with the transmitter output port “r”, a threshold detector circuit 914 coupled with the transmitter input port “g”, a signal toggler circuit 942 coupled with the transmitter output port “w” and a toggle detector 944 coupled with the transmitter input port “a”. Furthermore, the data receiver 908 further includes a threshold detector circuit 914 coupled with the receiver input port “r”, a signal asserter/de-asserter circuit 912 coupled with the receiver output port “g”, a toggle detector 944 coupled with the receiver input port “w” and a signal toggler circuit 942 coupled with the receiver output port “a”. Here, the signal toggler circuit 942 of the data transmitter 806 or the data receiver 908 can be implemented as a flip-flop (or latch), for instance. In addition, the signal asserter/de-asserter circuit 912 also can be implemented as a flip-flop (or latch), for instance.

The parallel data channel 704d (represented in FIG. 9B as a multiline) and the parallel signal channel 704s (represented in FIG. 9B as dotted lines) of the asynchronous communications interface 704 have been described in detail above in connection with FIG. 8. Example of implementations of the transmission request signal (TREQ), the transmission grant signal (TGNT), the write request signal (WREQ), the write acknowledgment signal (WACK), the completion request signal and the transmission denial signal noted above in connection with FIG. 8 will be described below in reference with the timing diagram 900 shown in FIG. 9A and the components of the data transmitter 906 and the data receiver 908 shown in FIG. 9B.

At time 910, the data transmitter 906 uses the signal asserter/de-asserter circuit 912 to assert a request signal (REQ_Assert) on the dedicated request signal line of the parallel signal channel 704s. Note that, prior to asserting the request signal, the data transmitter 906 determines that the request signal is un-asserted, i.e., the request signal is low, and that a grant signal also is un-asserted, i.e., the grant signal is low. By asserting the request signal, the signal asserter/de-asserter circuit 912 of the data transmitter 906 causes a transition of the request signal from low to high. The assertion of the request signal is detected on the dedicated request signal line by the threshold detector circuit 914 of the data receiver 908. As described above in connection with FIG. 8, detection by the data receiver 908 of the assertion of the request signal represents a request by the data transmitter 906 to begin transmission of a data packet from the data transmitter to the data receiver. Accordingly, in response to detecting that the request signal has been asserted, an arbiter module of the data receiver 908 checks whether the data receiver is currently receiving, or is scheduled to receive, data from one or more other transmitters. In some implementations, the arbiter module of the data receiver 908 can perform arbiter functions based on a round-robin rule, or other arbiter rules.

Once the arbiter module of the data receiver 908 determines that the data receiver is ready to receive data transmissions from the data transmitter 906, the data receiver uses the signal asserter/de-asserter circuit 912 to assert, at time 920, a grant signal (GNT_Assert) on the dedicated grant signal line of the parallel signal channel 704s. By asserting the grant signal, the signal asserter/de-asserter circuit 912 of the data receiver 908 causes a transition of the grant signal from low to high. The assertion of the grant signal is detected on the dedicated grant signal line by the threshold detector circuit 914 of the data transmitter 906 at a time 920+T_{PROP,g}. Here, the delay T_{PROP,g} is a time it takes for the transition between the un-asserted and asserted states of the grant signal to propagate from the data receiver 908 on the dedicated grant signal line to the data transmitter 906. Note that an upper bound for the delay T_{PROP,g} can be in a range of 1-5 ns for a network on a chip device 102, 102A described above in this specification.

In response to detecting that the grant signal has been asserted, the data transmitter 906 places, at time 930 (where time 930≧time 920+T_{PROP,g}), DATA A stored in the egress buffer 932 on the parallel data channel 704d. Note that placement of DATA A on the parallel data channel 704d can be performed by controller circuitry of the egress buffer 932 and corresponds to the start of the first data transfer of multiple data transfers used to transmit the data packet from the data transmitter 906 to the data receiver 908. Once DATA A corresponding to the first data transfer is placed on the parallel data channel 704d, the data transmitter 906 waits a predetermined amount of time δT. As explained above in connection with FIG. 8, a time difference between a valid state of a bit of DATA A that is placed on the effectively longest data line of the parallel data channel 704d and a valid state of a bit of DATA A that is placed on the effectively shortest data line of the parallel data channel corresponds to a maximum delay ΔT_{MAX}. For this reason, the predetermined amount of time δT that the data transmitter 906 waits after placing the data on the parallel data channel 704d is larger than or equal to the maximum delay Δ_{TMAX}. As noted above, the predetermined amount of time δT associated with the asynchronous communications interface 704 can be up to 100 ps, when the disclosed asynchronous communications interface is used in conjunction with a network on a chip device 102, 102A described above in this specification.

After waiting the predetermined amount of time δT, the data transmitter 906 uses the signal toggler circuit 942 to toggle, at time 940 (where time 940=time 930+δT), a write signal (WRI_TOG) on the dedicated write signal line of the parallel signal channel 704s. By toggling the write signal, the signal toggler circuit 942 of the data transmitter 906 causes a transition of the write signal from its current state (low or high) to its other possible state (high or low, respectively). The toggle of the write signal is detected on the dedicated write signal line by the toggle detector circuit 944 of the data receiver 908 at a time 940+T_{PROP,w}. Here, the delay T_{PROP,w} is a time it takes for the transition between the states of the write signal to propagate from the data transmitter 906 on the dedicated write signal line to the data receiver 908. Note that the delay T_{PROP,w} can be in a range of 1-5 ns for a network on a chip device 102, 102A described above in this specification. As described above in connection with FIG. 8, detection of the toggle of the write signal represents a confirmation that all bits of DATA A placed on the parallel data channel 704d by the data transmitter 906 have reached the data receiver 908 and can be captured by the data receiver. Accordingly, in response to detecting the toggle of the write signal, the data receiver 908 stores DATA A from the parallel data channel 704d in the ingress buffer 934 of the data receiver. Here, the storing of DATA A in the ingress buffer 934 can be performed by controller circuitry of the ingress buffer.

Once the data receiver 908 stores DATA A in the ingress buffer 934, the data receiver uses the signal toggler circuit 942 to toggle, at time 950 (where time 950≧time 940+T_{PROP,w}), an acknowledgment signal (ACK_TOG) on the dedicated acknowledgment signal line of the parallel signal channel 704s. By toggling the acknowledgment signal, the signal toggler circuit 942 of the data receiver 908 causes a transition of the acknowledgment signal from its current state (low or high) to its other possible state (high or low, respectively). The toggle of the acknowledgment signal is detected on the dedicated acknowledgment signal line by the toggle detector circuit 944 of the data transmitter 906 at a time 950+T_{PROP,a}. Here, the delay T_{PROP,a} is a time it takes for the transition between the states of the acknowledgment signal to propagate from the data receiver 908 on the dedicated acknowledgment signal line to the data transmitter 906. Note that the delay T_{PROP,a} can be in the range of 1-5 ns for a network on a chip device 102, 102A described above in this specification. As described above in connection with FIG. 8, detection of the toggle of the acknowledgment signal represents a confirmation that DATA A has been captured by the data receiver 908. Accordingly, in response to detecting the toggle of the acknowledgment signal, the data transmitter 906 determines whether additional data transfers are necessary to complete the transmission of the data packet. In the example illustrated in FIG. 9A, at least another transfer is necessary.

As such, the data transmitter 906 places, at time 930′ (where time 930′≧time 950+T_{PROP,a}), DATA B stored in the egress buffer 932 on the parallel data channel 704d. Note that placement of DATA B on the parallel data channel 704d corresponds to the start of the second data transfer of the multiple data transfers used to transmit the data packet from the data transmitter 906 to the data receiver 908. Once DATA B corresponding to the second data transfer is placed on the parallel data channel 704d, the data transmitter 906 waits the predetermined amount of time δT. After waiting the predetermined amount of time δT, the data transmitter 906 uses the signal toggler circuit 942 to toggle, at time 940′ (where time 940′=time 930′+δT), the write signal (WRI_TOG) on the dedicated write signal line of the parallel signal channel 704s. The toggle of the write signal is detected on the dedicated write signal line by the toggle detector circuit 944 of the data receiver 908 at a time 940′+T_{PROP,w}. In response to detecting the toggle of the write signal, the data receiver 908 stores DATA B from the parallel data channel 704d in the ingress buffer 934 of the data receiver.

Once the data receiver 908 stores DATA B in the ingress buffer 934, the data receiver uses the signal toggler circuit 942 to toggle, at time 950′ (where time 950′≧time 940′+T_{PROP,w}), the acknowledgment signal (ACK_TOG) on the dedicated acknowledgment signal line of the parallel signal channel 704s. The toggle of the acknowledgment signal is detected on the dedicated acknowledgment signal line by the toggle detector circuit 944 of the data transmitter 906 at a time 950′+T_{PROP,a}. In response to detecting the toggle of the acknowledgment signal, the data transmitter 906 determines whether additional data transfers are necessary to complete transmission of the data packet.

In response to determining by the data transmitter 906 that the transmission of the data packet has been completed, the data transmitter uses the signal asserter/de-asserter circuit 912 to de-assert, at time 960, the request signal (REQ_De-assert) on the dedicated request signal line of the parallel signal channel 704s. By de-asserting the request signal, the signal asserter/de-asserter circuit 912 of the data transmitter 906 causes a transition of the request signal from high to low. The de-assertion of the request signal is detected on the dedicated request signal line by the threshold detector circuit 914 of the data receiver 908 at a time 960+T_{PROP,r}. Here, the delay T_{PROP,r} is a time it takes for the transition between the asserted and un-asserted states of the request signal to propagate from the data transmitter 906 on the dedicated request signal line to the data receiver 908. Note that an upper bound for the delay T_{PROP,r} can be in a range of 1-5 ns for a network on a chip device 102, 102A described above in this specification. In response to detecting the de-asserting of the request signal, the data receiver 908 uses the signal asserter/de-asserter circuit 912 to de-assert, at time 970 (where time 970≧time 960+T_{PROP,r}), the grant signal (GNT_De-assert) on the dedicated grant signal line of the parallel signal channel 704s. By de-asserting the grant signal, the signal asserter/de-asserter circuit 912 of the data receiver 908 causes a transition of the grant signal from high to low. At this point, the arbiter module of the data receiver 908 can address grant requests for data packet transmissions from other data receivers.

In some implementations, a method may be specified as in the following clauses.

1. A method performed by a data transmitting computing resource operating in a first clock domain of a computing system, the method comprising:

determining that a data receiving computing resource operating in a second clock domain of the computing system different from the first clock domain has granted a request to perform one or more data transfers to transmit a data packet to the data receiving computing resource;

after determining that the data receiving computing resource has granted the request, placing data corresponding to a data transfer of the one or more data transfers on a parallel data channel comprising a plurality of data lines connecting the data transmitting computing resource and the data receiving computing resource;

waiting a predetermined amount of time after the placing of the data corresponding to the data transfer on the parallel data channel, the predetermined amount of time based on different propagation times of the plurality of data lines; and

after waiting the predetermined amount of time, notifying the data receiving computing resource that the data placed on the parallel data channel are valid.

2. The method of clause 1, wherein

at least some of the plurality of data lines of the parallel data channel have different effective lengths, such that a time difference between a valid state of a data bit placed on the effectively longest data line from among the plurality of data lines and a valid state of a data bit placed on the effectively shortest data line from among the plurality of data lines corresponds to a maximum delay, and

the predetermined amount of time is larger than or equal to the maximum delay.

3. The method of clause 1, further comprising receiving an acknowledgement that the data placed on the parallel data channel has been captured by the data receiving computing resource.

4. The method of clause 3, wherein the receiving of the acknowledgement that the at least the portion of the data packet has been captured by the data receiving computing resource comprises detecting that a write acknowledge signal has toggled after performing the data transfer.

5. The method of clause 3, further comprising:

after the receiving of the acknowledgement that the data placed on the parallel data channel has been captured by the data receiving computing resource, placing second data corresponding to a second data transfer of the one or more data transfers on the parallel data channel;

waiting the predetermined amount of time after the placing of the second data corresponding to the second data transfer on the parallel data channel; and

after the waiting of the predetermined amount of time, notifying the data receiving computing resource that the second data placed on the parallel data channel are valid.

6. The method of clause 3, further comprising notifying the data receiving computing resource that performing of the one or more data transfers is complete.

7. The method of clause 6, wherein the notifying the data receiving computing resource that performing of the one or more data transfers is complete comprises de-asserting a previously asserted request signal.

8. The method of clause 1, further comprising providing the request to perform the one or more data transfers to the data receiving computing resource.

9. The method of clause 8, wherein the providing the request to perform the one or more data transfers comprises asserting a previously un-asserted request signal.

10. The method of clause 8, further comprising:

before the providing of the request to perform one or more data transfers, detecting that a grant signal provided by the data receiving computing resource is un-asserted.

11. The method of clause 8, wherein the determining that the data receiving computing resource has granted the request to perform the one or more data transfers comprises detecting a grant signal being asserted after providing the request.

12. The method of clause 1, wherein the notifying the data receiving computing resource that data placed on the parallel data channel are valid comprises toggling a write signal.

In some implementations, a method may be specified as in the following clauses.

13. A method performed by a data receiving computing resource operating in a first clock domain of a computing system, the method comprising:

notifying a data transmitting computing resource operating in a second clock domain of the computing system different from the first clock domain that a request to perform one or more data transfers to transmit a data packet from the data transmitting computing resource to the data receiving computing resource over a parallel data channel comprising a plurality of data lines is granted;

after notifying the data transmitting computing resource that the request to perform the one or more data transfers is granted, waiting to receive from the data transmitting computing resource an indication that data placed by the data transmitting computing resource on the parallel data channel are valid;

in response to receiving the indication that the data placed on the parallel data channel are valid, capturing the data placed on the parallel data channel; and

providing an acknowledgement to the data transmitting computing resource that the data placed on the parallel data channel has been captured.

14. The method of clause 13, wherein

at least some of the plurality of data lines of the parallel data channel have different effective lengths, such that a time difference between a valid state of a data bit placed on the longest data line from among the plurality of data lines and a valid state of a data bit placed on the shortest data line from among the plurality of data lines corresponds to a maximum delay, and

a time difference between the valid state of the data bit placed on the shortest data line and a time when the indication that the data placed on the parallel data channel are valid is received is at most a predetermined amount of time, the predetermined amount of time being larger than or equal to the maximum delay.

15. The method of clause 13, further comprising:

after the providing of the acknowledgement that the data placed on the parallel data channel has been captured, waiting to receive from the data transmitting computing resource a second indication that second data placed by the data transmitting computing resource on the parallel data channel are valid;

in response to receiving the second indication that the second data placed on the parallel data channel are valid, capturing the second data placed on the parallel data channel; and

providing a second acknowledgement to the data transmitting computing resource that the second data placed on the parallel data channel has been captured.

16. The method of clause 13, further comprising determining that the performing of the one or more data transfers by the data transmitting computing resource is complete.

17. The method of clause 16, wherein the determining that the performing of the one or more data transfers by the data transmitting computing resource is complete comprises detecting that a previously asserted request signal has been de-asserted.

18. The method of clause 13, further comprising receiving from the data transmitting computing resource the request to perform the one or more data transfers.

19. The method of clause 18, wherein the receiving of the request to perform the one or more data transfers comprises receiving an asserted request signal.

20. The method of clause 18, wherein the notifying the data transmitting computing resource that the request to perform the one or more data transfers is granted comprises asserting a previously un-asserted grant signal after receiving the request.

21. The method of clause 13, wherein receiving the indication that the data placed on the parallel data channel are valid comprises detecting that a write signal has toggled.

22. The method of clause 13, wherein providing the acknowledgement that the placed on the parallel data channel has been captured comprises detecting that a write acknowledge signal has been toggled.

23. The method of clause 13, further comprising:

after providing the acknowledgement that the data placed on the parallel data channel has been captured, waiting to receive from the data transmitting computing resource an indication that second data placed by the data transmitting computing resource on the parallel data channel are valid;

in response to receiving the indication that the second data placed on the parallel data channel are valid, capturing the second data placed on the parallel data channel; and

providing a second acknowledgement to the data transmitting computing resource that the second data placed on the parallel data channel packet has been captured.

In some implementations, a computing system may be configured as specified in the following clauses.

24. A computing system comprising:

a data transmitting computing resource operating in a first clock domain of the computing system;

a data receiving computing resource operating in a second clock domain of the computing system different from the first clock domain;

a parallel data channel comprising a plurality of data lines connecting the data transmitting computing resource and the data receiving computing resource; and

parallel signal channel comprising a request signal line, a grant signal line, a write signal line and an acknowledgment signal line connecting the data transmitting computing resource and the data receiving computing resource,

wherein the data transmitting computing resource comprises:
an egress buffer configured to store at least data corresponding to a first data transfer of one or more data transfers to transmit a data packet from the data transmitting computing resource to the data receiving computing resource,
a threshold detector circuit configured to detect that a grant signal has been asserted on the grant signal line,
controller circuitry of the egress buffer configured to place, on the parallel data channel after detection that the grant signal has been asserted, the data corresponding to the first transmission from the egress buffer, and
a signal toggler circuit configured to wait a predetermined amount of time after the data corresponding to the first data transfer has been placed on the parallel data channel, and then toggle a write signal on the write signal time, and

wherein the data receiving computing resource comprises:
an ingress buffer,
a signal asserter/de-asserter circuit configured to assert the grant signal on the grant signal line,
a toggle detector circuit configured to wait, after assertion of the grant signal, and detect that the write signal on the write signal time has been toggled, and
controller circuitry of the ingress buffer configured to store, in the ingress buffer in response to detection that the write signal has been toggled, the data corresponding to the first transmission from the parallel data channel.

25. The computing system of clause 25, wherein:

at least some of the plurality of data lines of the parallel data channel have different effective lengths, such that a time difference between a valid state of a data bit placed on the effectively longest data line from among the plurality of data lines and a valid state of a data bit placed on the effectively shortest data line from among the plurality of data lines corresponds to a maximum delay, and

the predetermined amount of time is larger than or equal to the maximum delay.

26. The computing system of clause 25, wherein

the data receiving computing resource further comprises a signal toggler circuit configured to toggle, after the data corresponding to the first transmission has been stored, an acknowledgment signal on the acknowledgment signal line, and

the data transmitting computing resource further comprises a toggle detector circuit configured to detect that the acknowledgment signal on the acknowledgment signal line has been toggled.

27. The computing system of clause 27, wherein:

the egress buffer further stores data corresponding to a second data transfer of the one or more data transfers to transmit the data packet,

the controller circuitry of the egress buffer is configured to place, after the toggle of the acknowledgement signal has been detected, data corresponding to the second data transfer on the parallel data channel,

the signal toggler circuit of the data transmitting computing resource is configured to wait the predetermined amount of time after the data corresponding to the second data transfer has been placed on the parallel data channel, and then toggle the write signal on the write signal time,

the toggle detector circuit of the data receiving computing resource is configured to wait, after the acknowledgment signal has been toggled, and detect that the write signal on the write signal time has been toggled,

the controller circuitry of the ingress buffer is configured to store, in the ingress buffer in response to detection that the write signal has been toggled, the data corresponding to the second transmission from the parallel data channel, and

the signal toggler circuit of the data receiving computing resource is configured to toggle, after the data corresponding to the second transmission has been stored, the acknowledgment signal on the acknowledgment signal line.

28. The computing system of clause 27, wherein

the data transmitting computing resource further comprises a signal asserter/de-asserter circuit is configured to
assert a request signal on the request signal line prior to detection that the grant signal has been asserted, and
de-assert the request signal on the request signal line in response to determination by the controller circuitry of the egress buffer that transmission of the data packet is complete,

the data receiving computing resource further comprises a threshold detector circuit configured to detect that the request signal has been
asserted on the request signal line prior to assertion of the grant signal on the grant signal line, and
de-asserted on the request signal line after the acknowledgment signal has been toggled on the acknowledgment signal line, and

the signal asserter/de-asserter circuit of the data receiving computing resource is configured to de-assert the grant signal on the grant signal line in response to detection that the request signal has been de-asserted on the request signal line.

In the above description, numerous specific details have been set forth in order to provide a thorough understanding of the disclosed technologies. In other instances, well known structures, interfaces, and processes have not been shown in detail in order to avoid unnecessarily obscuring the disclosed technologies. However, it will be apparent to one of ordinary skill in the art that those specific details disclosed herein need not be used to practice the disclosed technologies and do not represent a limitation on the scope of the disclosed technologies, except as recited in the claims. It is intended that no part of this specification be construed to effect a disavowal of any part of the full scope of the disclosed technologies. Although certain embodiments of the present disclosure have been described, these embodiments likewise are not intended to limit the full scope of the disclosed technologies.

While specific embodiments and applications of the disclosed technologies have been illustrated and described, it is to be understood that the disclosed technologies are not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the disclosed technologies disclosed herein without departing from the spirit and scope of the disclosed technologies. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application--such as by using any combination of control circuitry, e.g., state machines, microprocessors, microcontrollers, field programmable gate arrays (FPGAs), application specific integrated circuits (ASICs), and/or System on a Chip (SoC)—but such implementation decisions should not be interpreted as causing a departure from the scope of the disclosed technologies.

The steps of a method or algorithm described in connection with the embodiments disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the disclosed technologies. In other words, unless a specific order of steps or actions is required for proper operation of the embodiment, the order and/or use of specific steps and/or actions may be modified without departing from the scope of the disclosed technologies.

What is claimed is:

1. A method performed by a data transmitting computing resource operating in a first clock domain of a computing system, the method comprising:
determining that a data receiving computing resource operating in a second clock domain of the computing system different from the first clock domain has granted a request to perform one or more data transfers to transmit a data packet to the data receiving computing resource;
after determining that the data receiving computing resource has granted the request, placing data corresponding to a data transfer of the one or more data transfers on a parallel data channel comprising a plurality of data lines connecting the data transmitting computing resource and the data receiving computing resource;
waiting a predetermined amount of time after the placing of the data corresponding to the data transfer on the parallel data channel, the predetermined amount of time based on different propagation times of the plurality of data lines; and
after waiting the predetermined amount of time, notifying the data receiving computing resource that the data placed on the parallel data channel are valid.

2. The method of claim 1, wherein
at least some of the plurality of data lines of the parallel data channel have different effective lengths, such that a time difference between a valid state of a data bit placed on the effectively longest data line from among the plurality of data lines and a valid state of a data bit placed on the effectively shortest data line from among the plurality of data lines corresponds to a maximum delay, and
the predetermined amount of time is larger than or equal to the maximum delay.

3. The method of claim 1, further comprising receiving an acknowledgement that the data placed on the parallel data channel has been captured by the data receiving computing resource.

4. The method of claim 3, wherein the receiving of the acknowledgement that the at least the portion of the data packet has been captured by the data receiving computing resource comprises detecting that a write acknowledge signal has toggled after performing the data transfer.

5. The method of claim 3, further comprising:
after the receiving of the acknowledgement that the data placed on the parallel data channel has been captured by the data receiving computing resource, placing second data corresponding to a second data transfer of the one or more data transfers on the parallel data channel;
waiting the predetermined amount of time after the placing of the second data corresponding to the second data transfer on the parallel data channel; and
after the waiting of the predetermined amount of time, notifying the data receiving computing resource that the second data placed on the parallel data channel are valid.

6. The method of claim 3, further comprising notifying the data receiving computing resource that performing of the one or more data transfers is complete.

7. The method of claim 6, wherein the notifying the data receiving computing resource that performing of the one or more data transfers is complete comprises de-asserting a previously asserted request signal.

8. The method of claim 1, further comprising providing the request to perform the one or more data transfers to the data receiving computing resource.

9. The method of claim 8, wherein the providing the request to perform the one or more data transfers comprises asserting a previously un-asserted request signal.

10. The method of claim 8, further comprising:
before the providing of the request to perform one or more data transfers, detecting that a grant signal provided by the data receiving computing resource is un-asserted.

11. The method of claim 8, wherein the determining that the data receiving computing resource has granted the request to perform the one or more data transfers comprises detecting a grant signal being asserted after providing the request.

12. The method of claim 1, wherein the notifying the data receiving computing resource that data placed on the parallel data channel are valid comprises toggling a write signal.

13. A method performed by a data receiving computing resource operating in a first clock domain of a computing system, the method comprising:
notifying a data transmitting computing resource operating in a second clock domain of the computing system different from the first clock domain that a request to perform one or more data transfers to transmit a data packet from the data transmitting computing resource to the data receiving computing resource over a parallel data channel comprising a plurality of data lines is granted;
after notifying the data transmitting computing resource that the request to perform the one or more data transfers is granted, waiting to receive from the data transmitting computing resource an indication that data placed by the data transmitting computing resource on the parallel data channel are valid;
in response to receiving the indication that the data placed on the parallel data channel are valid, capturing the data placed on the parallel data channel; and
providing an acknowledgement to the data transmitting computing resource that the data placed on the parallel data channel has been captured.

14. The method of claim 13, wherein at least some of the plurality of data lines of the parallel data channel have different effective lengths, such that a time difference between a valid state of a data bit placed on the longest data line from among the plurality of data lines and a valid state of a data bit placed on the shortest data line from among the plurality of data lines corresponds to a maximum delay, and
a time difference between the valid state of the data bit placed on the shortest data line and a time when the indication that the data placed on the parallel data channel are valid is received is at most a predetermined amount of time, the predetermined amount of time being larger than or equal to the maximum delay.

15. The method of claim 13, further comprising:
after the providing of the acknowledgement that the data placed on the parallel data channel has been captured, waiting to receive from the data transmitting computing resource a second indication that second data placed by the data transmitting computing resource on the parallel data channel are valid;
in response to receiving the second indication that the second data placed on the parallel data channel are valid, capturing the second data placed on the parallel data channel; and
providing a second acknowledgement to the data transmitting computing resource that the second data placed on the parallel data channel has been captured.

16. The method of claim 13, further comprising determining that the performing of the one or more data transfers by the data transmitting computing resource is complete.

17. The method of claim 16, wherein the determining that the performing of the one or more data transfers by the data transmitting computing resource is complete comprises detecting that a previously asserted request signal has been de-asserted.

18. The method of claim 13, further comprising receiving from the data transmitting computing resource the request to perform the one or more data transfers.

19. The method of claim 18, wherein the receiving of the request to perform the one or more data transfers comprises receiving an asserted request signal.

20. The method of claim 18, wherein the notifying the data transmitting computing resource that the request to perform the one or more data transfers is granted comprises asserting a previously un-asserted grant signal after receiving the request.

21. The method of claim 13, wherein receiving the indication that the data placed on the parallel data channel are valid comprises detecting that a write signal has toggled.

22. The method of claim 13, wherein providing the acknowledgement that the placed on the parallel data channel has been captured comprises detecting that a write acknowledge signal has been toggled.

23. The method of claim 13, further comprising:
after providing the acknowledgement that the data placed on the parallel data channel has been captured, waiting to receive from the data transmitting computing resource an indication that second data placed by the data transmitting computing resource on the parallel data channel are valid;
in response to receiving the indication that the second data placed on the parallel data channel are valid, capturing the second data placed on the parallel data channel; and
providing a second acknowledgement to the data transmitting computing resource that the second data placed on the parallel data channel packet has been captured.
